(19) United States
(12) Patent Application Publication
(10) Pub. No.: US 2006/0047777 A1
(43) Pub. Date: Mar. 2, 2006

(54) Enhancing portlet run-time display with dynamically applied portlet skins

(75) Inventors: Michael D. Harris, West Chester, OH (US); Stephan Hesmer, Raleigh, NC (US); Carol A. Jones, Raleigh, NC (US); David B. Lection, Raleigh, NC (US); Eric L. Masselle, Raleigh, NC (US)

Correspondence Address: Steven M. Greenberg, Esquire;Christopher & Weisberg, P.A., Suite 2040, 200 East Las Olas Boulevard, Fort Lauderdale, FL, 33301, US

(73) Assignee: International Business Machines Corporation, Armonk, NY (US)

(21) Appl. No.: 10/931,313

(22) Filed: Sep. 1, 2004

(51) Int. Cl. G06F 15/16

(52) U.S. Cl. 709/217

(57) ABSTRACT

A method, system and apparatus for enhancing the run-time display of a portlet using dynamically applied portlet skins. In this regard, a portlet display enhancement system can include a portlet aggregator configured to aggregate portlet views into a portal page, and alternate skin insertion logic programmed to wrap at least one portlet view with an alternate skin in lieu of a static skin. A portlet filter can be communicatively coupled to the portlet aggregator and configured to manage the alternate skin insertion logic. Alternatively, a servlet can be communicatively coupled to the portlet aggregator and configured to manage the alternate skin insertion logic. The alternate skin can include a debug skin. Moreover, the alternate skin can include an auxiliary control programmed to activate an auxiliary view. In this regard, the auxiliary view can include additional debug information.

### BACKGROUND OF THE INVENTION

1. Statement of the Technical Field

The present invention relates to the field of portals and portlets and more particularly to rendering the skin of a portlet in a portal environment.

2. Description of the Related Art

Distributing content about large computer communications networks is not without its challenges. In particular, the quantity of content available for distribution in a computer communications network often varies proportionally to the size of the computer communications network. At the extreme, the Internet hosts a vast quantity of content not easily accessible by most end-users. Portals represent a sensible solution to the problem of aggregating content through a channel paradigm in a single, network-addressable location. In consequence, portals have become the rage in content distribution.

Portlets are the visible active components included as part of portal pages. Similar to the graphical windows paradigm of windowing operating systems, each portlet in a portal occupies a portion of the portal page through which the portlet can display associated content from a portlet channel. Portlets are known to include both simple applications such as an electronic mail client, and also more complex applications such as forecasting output from a customer relationship management system. The prototypical portlet can be implemented as server-side scripts executed through a portal server.

From the end-user perspective, a portlet is a content channel or application to which the end-user can subscribe. By comparison, from the perspective of the content provider, a portlet is a means through which content can be distributed in a personalized manner to a subscribing end-user. Finally, from the point of view of the portal, a portlet merely is a component which can be rendered within the portal page. In any case, by providing one or more individually selectable and configurable portlets in a portal, portal providers can distribute content and applications through a unified interface in a personalized manner according to the preferences of the end-user.

Portal servers are computer programs which facilitate the distribution of portal based Web sites on the public Internet or a private intranet. Importantly, it will be recognized by one of ordinary skill in the art that the signature characteristic of all conventional portal servers can include the aggregation of content from several portlet applications within a single distributable page in a uniform manner. To that end, each portlet application within the portal page can be represented by a static portlet user interface, or “skin”, distributed by the portal server to requesting client computing devices.

As information technologists deploy portal technology into the enterprise, information technologists continuously struggle with the dual issues of portlet application development and deployment. To complicate matters, because a target portal may not operate in the local computing space of the developer, but in a remote computing space, there will be aspects of the portlet testing cycle that can be accomplished only within a remote portal server. While conventional portal development platforms provide a debug capability for locally deployed portlets, conventional debuggers provide no value add for portlets in the remote debugging scenario.

### SUMMARY OF THE INVENTION

The present invention addresses the deficiencies of the art in respect to rendering the static skin of a portlet in a portal environment and provides a novel and non-obvious method, system and apparatus for enhancing the run-time display of a portlet using dynamically applied alternate portlet skins. In this regard, a portlet display enhancement system can include a portlet aggregator configured to aggregate portlet views into a portal page, and alternate skin insertion logic programmed to wrap at least one portlet view with an alternate skin in lieu of a static skin.

In a preferred aspect of the invention, a portlet filter can be communicatively coupled to the portlet aggregator and configured to manage the alternate skin insertion logic. Alternatively, a servlet can be communicatively coupled to the portlet aggregator and configured to manage the alternate skin insertion logic. In a specific implementation of the present invention, the alternate skin can include a debug skin for assisting the testing cycle of the portlet logic. Moreover, the alternate skin can include an auxiliary control programmed to activate an auxiliary view. In this regard, the auxiliary view can include additional debug information for use in remotely debugging the operation of the portlet.

A portlet display enhancement method can include the step of applying an alternate skin to a portlet in lieu of a statically specified skin. For instance, the step of applying can include the step of, responsive to a request to aggregate the portlet in a portal page, determining whether an alternate skin is to be applied to the portlet in lieu of a statically specified skin, and, rendering the alternate skin if it is determined that the alternate skin is to be applied. More specifically, the rendering step can include the steps of: first rendering a pre-portlet portion of the alternate skin; second rendering the portlet; and, third rendering a post-portlet portion of the alternate skin. Finally, each of the rendered pre-portlet portion, portlet, and post-portlet portion can be inserted into a portal stream for forwarding to a content browser.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a system, method and apparatus for enhancing the run-time display of a portlet using dynamically applied portlet skins;

FIG. 2 is a schematic illustration of a portal rendering system configured to enhance the run-time display of a portlet using a dynamically applied portlet skin; and,

FIG. 3 is a flow chart illustrating a process for enhancing the run-time display of a portlet using dynamically applied portlet skins.

### DETAILED DESCRIPTION OF THE PREFERRED EMBODIMENTS

The present invention is a method, system and apparatus for enhancing the run-time display of a portlet using dynamically applied portlet skins. In accordance with the present invention, an alternate skin can be generated and applied to a portlet dynamically in a portal environment during a portal aggregation operation. The alternate skin, for example, can be a debug skin useful in debugging the operation of the portlet—particularly where the portlet view is rendered through a remote portal server. The debug skin further can incorporate logic responsive to the operation of the portlet so as to provide enhanced diagnostic capabilities.

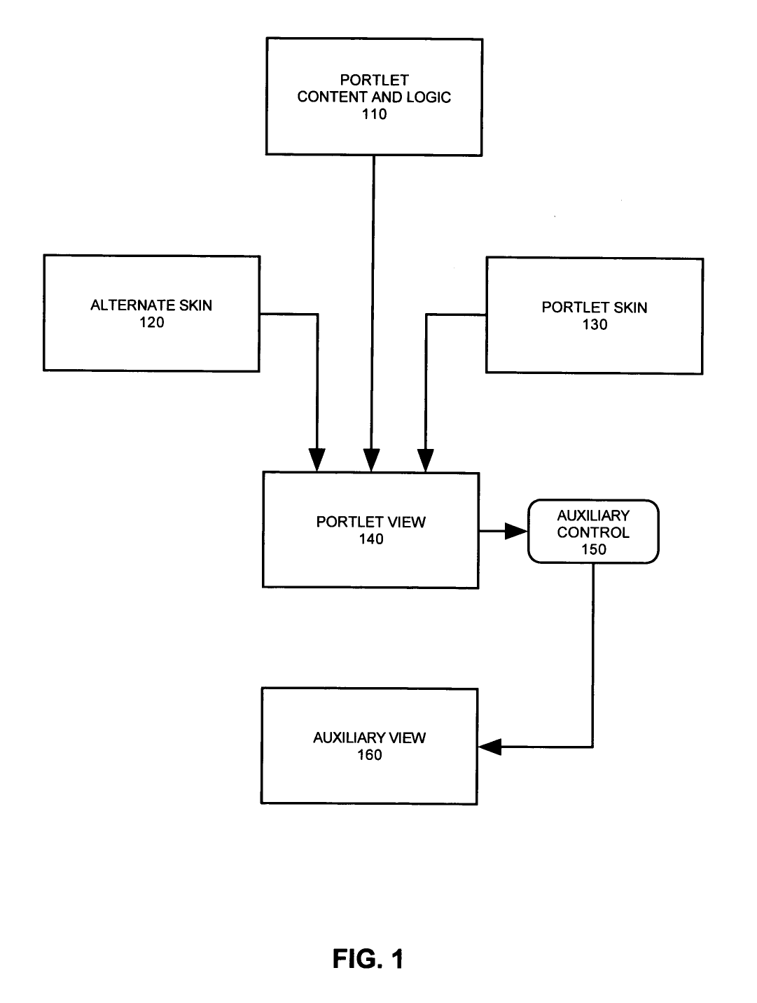

In more particular illustration, FIG. 1 depicts a system, method and apparatus for enhancing the run-time display of a portlet using dynamically applied portlet skins. As shown in FIG. 1, portlet content and logic 110 can be rendered by a portal aggregator to produce a portal view 140. As part of the portal aggregation process, a portlet skin 130 can be applied to the portlet view 140 to provide visually interactive functionality to the portlet content logic 110, for example through the inclusion of a title bar, frame outline, help, minimize, maximize and normalize buttons, and the like.

Central to the invention, an alternate skin 120 can be applied to the portlet content and logic 110 in lieu of or in addition to the portlet skin 130. The alternate skin 120, for example, can include logic for displaying portlet output as well as debug information in the portal. For example, the alternate skin 120 can be an active server pages such as a Java Server Page (JSP) having associated JSP tags able to produce markup for displaying debug information in the portlet view 140.

Notably, application of the alternate skin 120 is not limited to a single debug function. Rather, the alternate skin 120 can incorporate multiple debug functions such as analyzing the content emitted by the portlet content and logic 110 in the portlet view 140, and performing an action based upon that content. In this regard, an activatable control 150 can be included in the alternate skin 120 for performing computing actions from within the portlet view 140. The activatable control 150, when selected, can produce an additional view 160. For instance, where the alternate skin 120 is a debug skin, the activatable control 150 can produce and render a viewable debug report in a separate window based upon the operation of the portlet content and logic 110.

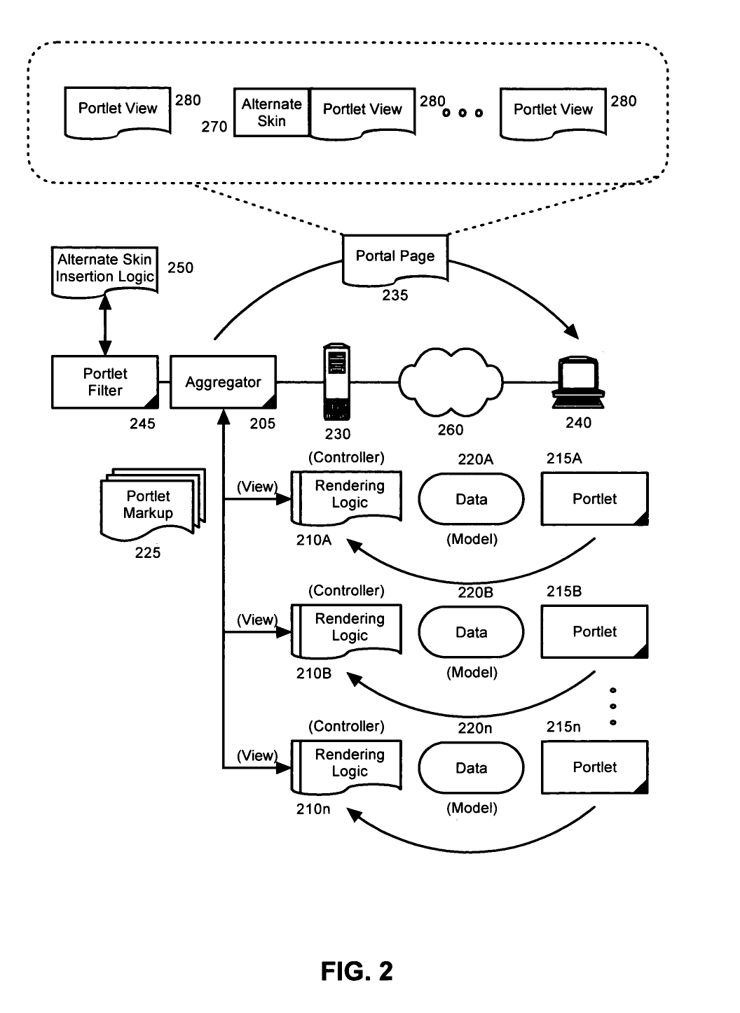

FIG. 2 is a schematic illustration of a portal rendering system configured to enhance the run-time display of a portlet using a dynamically applied portlet skin. The portal rendering system can include a portal page 235 communicatively coupled to a selection of portlet applications 215A, 215B, 215n through a portal server 230. Each portlet application 215A, 215B, 215n can produce a portlet view 280 based upon portlet data 220A, 220B, 220n in the form of portlet markup 225 through corresponding rendering logic 210A, 210B, 210n. Notably, the rendering logic 210A, 210B, 210n can be active markup such as a JSP, in which logical scriptlets can be embedded to produce specific markup language tags.

A portlet aggregator 205 can be coupled to each portlet application 215A, 215B, 215n to receive the portlet markup 225 and to aggregate the portlet markup 225 into view in the portal page 235. By aggregation, it is meant that the individual markup language blocks produced by each portlet 215A, 215B, 215n can be combined into a single cohesive markup language document configured for distribution to and use within a conventional content browser. In this regard, the portal page 235 can be disposed in the portal server 230 from which the portal 235 can be accessed by client content browsing devices 240 over a computer communications network 260 such as a local computer communications network, for instance a private intranet, or a global computer communications network, for instance the public Internet.

Importantly, a portlet filter 245 can be coupled to the portal aggregator 205. The portlet filter 245 can intercept requests to and responses from the aggregator 205. Through this interception mechanism, the portlet filter 245 can process logic responsive to the intercepted requests or intercepted responses. In accordance with the inventive arrangements, the portlet filter 245 can be configured to process alternate skin insertion logic 250 in response to the interception of a submit request. The alternate skin insertion logic 250 can respond to intercepted submit requests to apply a supplied alternate skin 270 to one or more portlet views 280 specified for aggregation in the portal page 235. Subsequently, the combined portal page 235 can be returned to the client content browsing device 240.

In more particular explanation of the dynamic application of an alternate skin 270 to a portlet view 280, dynamic application of the alternate skin 270 to a portlet view 280 can be accomplished by the portlet aggregator 205 calling the alternate skin insertion logic 250 of the portlet filter 245 before and after the render call to the portlet view 280. In the pre-portlet call, the alternate skin insertion logic 250 can receive a stream containing the alternate skin 270 and the alternate skin insertion logic 250 can invoke the dynamic skin JSP in the stream which can render the dynamic skin in the output stream of the portal page 235. In consequence, the pre-portlet skin content will have been added to the portal stream. Subsequently, the “doView” method of the portlet view 280 can be activated and the portlet view 280 can render its content to the output stream of the portal page 235. Once this process has completed, the alternate insertion logic 250 again can be called to add post-portlet skin content to the output stream of the portal page 235 via the activation of a post-skin JSP.

It will be recognized by the skilled artisan that by coupling the alternate skin insertion logic 250 to the aggregator 205 through a portlet filter 245, the alternate skin insertion logic 250 can be applied to any portal server 230, regardless of the source and configuration of the portal server 230. Specifically, it is well known that portlet filters generally implement a set of interfaces that allow the portlet filter to be connected in the request and response call sequence to each portlet view 280. Still, the invention is not so limited strictly to a portlet filter implementation. Rather, the alternate skin insertion logic 250 can be more directly linked to the portal server 230.

For example, in an alternative, non-portlet filter aspect of the invention, the portal server can replace the reference to the static skin for the portlet view with a reference to a servlet included in the render request. The portal server can achieve the replacement operation by adding the servlet to the classpath of the portal page and by mapping the servlet to the context root in lieu of the existing static skin. In this way, the servlet will be called instead of the static skin. Once the servlet gains control, the servlet first can call the pre-portlet portion of the alternate skin included in the stream, second can call the “doView” method of the portlet view to render the contents of the portlet view, and third can call the post-portlet portion of the alternate skin. When the servlet returns from operation, the servlet can be dynamically unmapped from the portal page. In consequence, skin customization can be enabled on a render-request basis and can be used to limit dynamic skins to certain users without requiring the use of portlet filters.

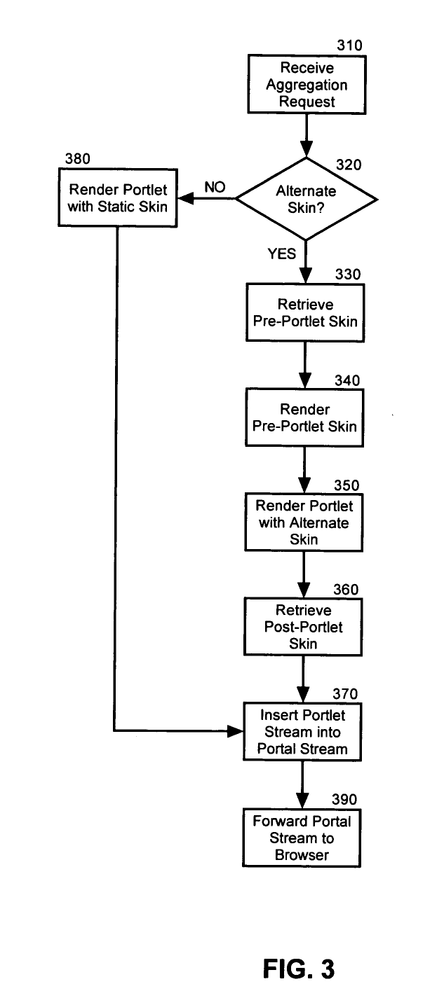

FIG. 3 is a flow chart illustrating a process for enhancing the run-time display of a portlet using dynamically applied portlet skins. Beginning in block 310, an aggregation request for a portlet can be received. Subsequently, in decision block 320, it can be determined whether an alternate skin is to be applied to portlet. For instance, the determination can be based upon the content of the request itself—particularly where the request is encapsulated within a uniform resource locator (URL). If, in decision block 320, it is determined that an alternate skin is not to be applied to the portlet, in block 380 the portlet can be rendered using the statically specified skin. As such, in block 370 the portlet with skin can be inserted into the portal stream which, in block 390 can be forwarded to the content browser for rendering.

Returning now to decision block 320, if it is determined that an alternate skin is to be added to the portlet, in block 330 a pre-portlet portion of the alternate skin (the portion of the alternate skin which is to be added prior to specifying rendering of the portlet view) can be retrieved from storage. Subsequently, in block 340 the pre-portlet skin can be rendered and in block 350 the portlet itself can be rendered. In block 360 the post-portlet portion of the alternate skin can be applied and in block 370, the portlet stream can be inserted into the portal stream. Finally, in block 390 the portal stream can be forwarded to a browser for rendering.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

We claim:

1. A portlet display enhancement system comprising:
a portlet aggregator configured to aggregate portlet views into a portal page; and,
alternate skin insertion logic programmed to wrap at least one portlet view with an alternate skin in lieu of a static skin.

2. The system of claim 1, further comprising a portlet filter communicatively coupled to said portlet aggregator and configured to manage said alternate skin insertion logic.

3. The system of claim 1, further comprising a servlet communicatively coupled to said portlet aggregator and configured to manage said alternate skin insertion logic.

4. The system of claim 1, wherein said alternate skin comprises a debug skin.

5. The system of claim 1, wherein said alternate skin comprises an auxiliary control programmed to activate an auxiliary view.

6. The system of claim 5, wherein said auxiliary view comprises additional debug information.

7. A portlet display enhancement method, comprising the step of applying an alternate skin to a portlet in lieu of a statically specified skin.

8. The method of claim 7, wherein said step of applying comprises the step of, responsive to a request to aggregate said portlet in a portal page, determining whether an alternate skin is to be applied to said portlet in lieu of a statically specified skin, and, rendering said alternate skin if it is determined that said alternate skin is to be applied.

9. The method of claim 8, wherein said rendering step comprises the steps of:
first rendering a pre-portlet portion of said alternate skin;
second rendering said portlet; and,
third rendering a post-portlet portion of said alternate skin.

10. The method of claim 9, further comprising the step of inserting said rendered pre-portlet portion, portlet, and post-portlet portion into a portal stream for forwarding to a content browser.

11. The method of claim 7, further comprising the step of inserting an auxiliary control in said alternate skin.

12. The method of claim 11, further comprising the step of launching an auxiliary view responsive to the activation of said auxiliary control.

13. The method of claim 12, further comprising the step of inserting debug information into said auxiliary view.

14. A machine readable storage having stored thereon a computer program for portlet display enhancement, the computer program comprising a routine set of instructions which when executed by a machine cause the machine to perform the step of applying an alternate skin to a portlet in lieu of a statically specified skin.

15. The machine readable storage of claim 14, wherein said step of applying comprises the step of, responsive to a request to aggregate said portlet in a portal page, determining whether an alternate skin is to be applied to said portlet in lieu of a statically specified skin, and, rendering said alternate skin if it is determined that said alternate skin is to be applied.

16. The machine readable storage of claim 15, wherein said rendering step comprises the steps of:
first rendering a pre-portlet portion of said alternate skin;
second rendering said portlet; and,
third rendering a post-portlet portion of said alternate skin.

17. The machine readable storage of claim 16, further comprising a routine set of instructions for additionally causing the machine to perform the step of inserting said rendered pre-portlet portion, portlet, and post-portlet portion into a portal stream for forwarding to a content browser.

18. The machine readable storage of claim 14, further comprising a routine set of instructions for additionally causing the machine to perform the step of inserting an auxiliary control in said alternate skin.

19. The machine readable storage of claim 18, further comprising a routine set of instructions for additionally causing the machine to perform step of launching an auxiliary view responsive to the activation of said auxiliary control.

20. The machine readable storage of claim 19, further comprising a routine set of instructions for additionally causing the machine to perform the step of inserting debug information into said auxiliary view.
